(19) United States
(12) Patent Application Publication
(10) Pub. No.: US 2021/0009057 A1
(43) Pub. Date: Jan. 14, 2021

(54) VEHICLE CABIN MONITORING SYSTEM AND TEMPERATURE CONTROL

(71) Applicant: MAGNA ELECTRONICS INC., Auburn Hills, MI (US)

(72) Inventors: Joern Ihlenburg, Berlin (DE); Boris Shulkin, West Bloomfield, MI (US); Benjamin May, Lübs (DE)

(21) Appl. No.: 17/031,958

(22) Filed: Sep. 25, 2020

Related U.S. Application Data
(63) Continuation of application No. 15/888,774, filed on Feb. 5, 2018.
(60) Provisional application No. 62/455,111, filed on Feb. 6, 2017.

(51) Int. Cl. B60R 16/037; B60H 1/00; G05D 23/19

(52) U.S. Cl. CPC B60R 16/037; B60H 1/00742; B60R 25/24; G05D 23/1917; B60R 2325/205; B60H 1/00657

(57) ABSTRACT

A control system for a vehicle includes a cabin monitoring system disposed at a vehicle and operable to detect presence of at least one occupant in the vehicle. The cabin monitoring system is operable to determine a temperature at an occupant detected in the vehicle. A control is operable to control a climate control system of the vehicle. The control, responsive to a determined temperature at a detected occupant, adjusts the temperature setting of the climate control system of the vehicle. The control system receives a remotely-provided profile from a source remote from the vehicle that is associated with a future occupant of the vehicle. The control system may adjust the temperature setting in accordance with remote-provided profile associated with the future occupant prior to arriving at a location for picking up the future occupant.

### CROSS REFERENCE TO RELATED APPLICATIONS

The present application is a continuation of U.S. patent application Ser. No. 15/888,774, filed Feb. 5, 2018, which claims the filing benefits of U.S. provisional application Ser. No. 62/455,111, filed Feb. 6, 2017, which is hereby incorporated herein by reference in its entirety.

### FIELD OF THE INVENTION

The present invention relates generally to a control system for a vehicle and, more particularly, to a control system that includes cabin monitoring capabilities.

### BACKGROUND OF THE INVENTION

Cabin monitoring systems are known that monitor an interior cabin of the vehicle to determine presence of an occupant in the vehicle. Examples of such systems are described in U.S. Pat. Nos. 8,258,932; 6,485,081 and 6,166,625, which are hereby incorporated herein by reference in their entireties.

### SUMMARY OF THE INVENTION

The present invention provides a driver assistance system or control system that utilizes a thermal imaging system for in cabin monitoring and that uses the system (such as in a highly or fully autonomous vehicle) to control a climate control system of the vehicle so that no occupant of the vehicle has a too cold or too hot heating scenario. The system may control the vehicle climate control system or may individually control separate climate control zones of the vehicle responsive to determination of the presence of one or more occupants in the vehicle. The system may control the climate control system of the vehicle to a preselected temperature selected by the particular occupant and part of a stored profile of that occupant.

These and other objects, advantages, purposes and features of the present invention will become apparent upon review of the following specification in conjunction with the drawings.

### BRIEF DESCRIPTION OF THE DRAWINGS

FIG. 1 is a side elevation of a vehicle with a control system that incorporates a cabin monitoring system in accordance with the present invention; and

FIG. 2 is a flow chart of the system of the present invention.

### DESCRIPTION OF THE PREFERRED EMBODIMENTS

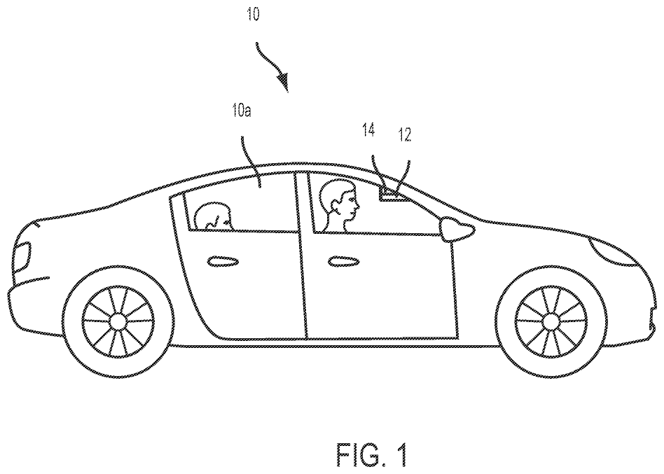

Referring now to the drawings and the illustrative embodiments depicted therein, a vehicle 10 includes an interior cabin monitoring system 12 that includes at least one interior viewing sensor, such as an imaging sensor or camera and such as a thermal sensing camera, which monitors the cabin 10a of the vehicle (FIG. 1). A control system 14 includes a control or electronic control unit (ECU) or processor that is operable to process data captured by the sensor of the cabin monitoring system to determine presence of an occupant or occupants in the vehicle seats. Responsive to detection of an occupant and responsive to determination of a temperature at the occupant, the system 14 may control a temperature setting of a vehicle climate system (such as the vehicle HVAC system) to adjust the temperature at the occupant to a desired or selected level. The system may communicate with the camera or sensor and with the climate system via any suitable vehicle communication means. For example, the data transfers or signal communications may comprise a vehicle network bus or the like of the equipped vehicle.

The present invention uses in-cabin sensors or cameras (such as, for example, thermal sensing cameras) to measure and monitor the temperatures at passengers in the vehicle (such as, for example, the skin temperature of passengers). For a group of people detected in the vehicle, different zones (climate zones) of the vehicle cabin may be taken into account to provide temperature control for each zone.

Once the individual books or enters a vehicle (such as a fully autonomous vehicle or robo taxi or the like, or for a typical taxi or Uber vehicle or the like), the in cabin thermal sensors can be adapted to his or her personal selected pre-settings. The system can identify if the passenger has too warm or too cold environment and can control the heating/climate control based on measurement data and also taking personal settings (if available) into account.

Thus, the in cabin monitoring systems acts as a sensor and control to personalize the interior of the vehicle (or only a portion or zone of the interior of the vehicle where the person is sitting). Optionally, the system may control more than temperature/climate. For example, the system may control or adjust sound settings or lighting in the vehicle in accordance with the detected passenger's personal preferences or settings. Optionally, for example, if the interior sensor system identifies that the person is sleepy, the system may change the settings of the interior music, lights, etc., optionally responsive to customized or selected presettings that pertain to the particular identified individual to ensure individual preferences are considered.

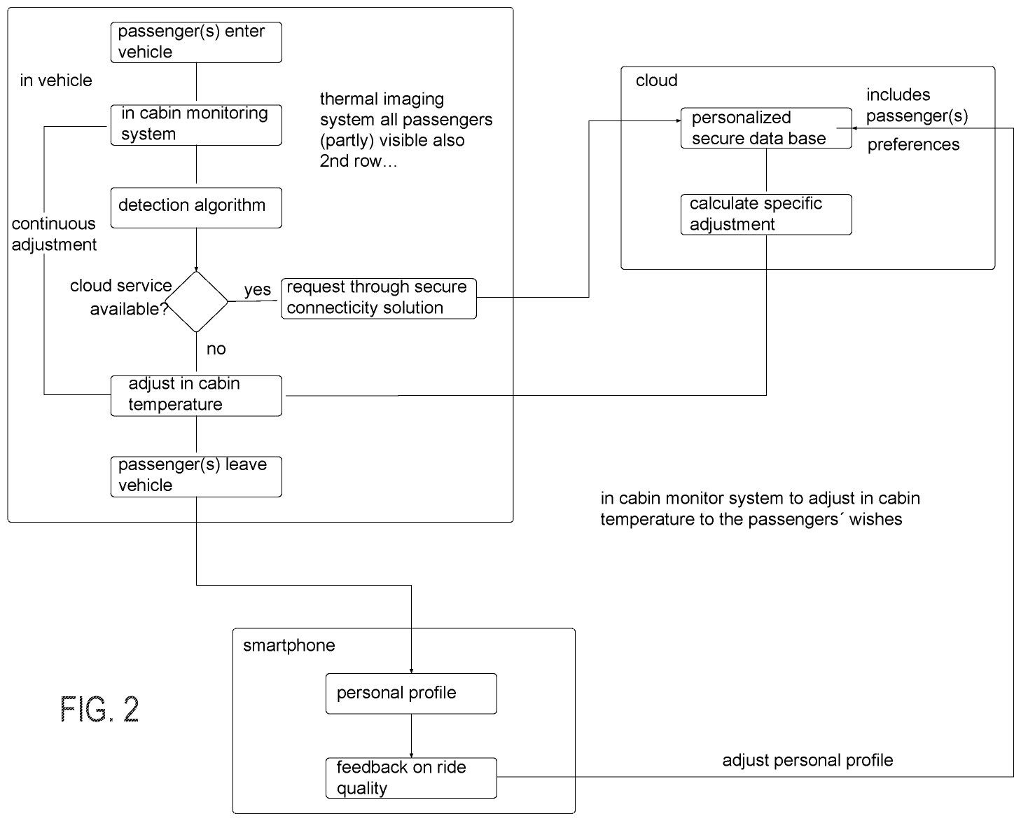

With reference to FIG. 2, the vehicle cabin monitoring system may determine when a passenger enters the vehicle (such as by detecting the presence of the passenger or such as in response to an input of a passenger entering the vehicle or such as responsive to a particular passenger booking the vehicle, whereby the system knows the particular passenger that will board the vehicle at that vehicle stopping location). After detection of the passenger, the system may determine the temperature at the passenger (via thermal imaging the passenger(s) that is/are present in the vehicle), and may adjust the in cabin temperature accordingly (and may continuously or episodically monitor the passenger temperature and make temperature control adjustments during the passenger(s)'s time in the vehicle). After the passenger leaves the vehicle, the passenger may use his or her smartphone to provide quality feedback about the ride (such as for fully autonomous transportation such as robo taxis or the like).

Optionally, a user of the autonomous vehicle transportation service may, such as by using his or her smartphone, set up a user profile that includes various personal preference settings, such as preferred temperature settings, lighting settings, audio settings and/or the like. Then the system, responsive to that particular user being identified in the vehicle (such as via the cabin monitoring system or via a signal from that person's smartphone or the like), the system may adjust the temperature, lighting and/or audio according to the user's selected preferences.

Optionally, the system may, when cloud services are available, communicate with a remote server or system to obtain the personalized profile or database for a particular user and can then adjust the cabin temperature (or lighting or audio) according to the user's profile. This approach is beneficial for autonomous public transportation systems (such as robo taxis or the like), whereby the control system of the vehicle can adjust the settings to the desired or selected levels or characteristics when the user has booked or called for the autonomous vehicle and before the user enters the vehicle. The system may be operable to only control a zone of the vehicle at which the user is seated, while similarly controlling other zones of the vehicle in accordance with the user preferences of the occupant(s) in the other zone(s). Optionally, the system may store multiple profiles of potential passengers (such as family members or coworkers that use the same vehicle) and may control the climate control system (and/or lighting and/or audio system) of the vehicle responsive to identification (such as via image processing of image data captured by a vehicle camera) of the particular passenger's face or other biometric identification (e.g., retinal scan, fingerprints or the like).

The system may also or otherwise utilize aspects of other cabin monitoring systems, such as those described in U.S. Pat. Nos. 8,258,932; 6,485,081 and 6,166,625, which are hereby incorporated herein by reference in their entireties. The system may utilize aspects of various cabin or passenger or driver monitoring systems, such as head and face direction and position tracking systems and/or eye tracking systems and/or gesture recognition systems. Such head and face direction and/or position tracking systems and/or eye tracking systems and/or gesture recognition systems may utilize aspects of the systems described in U.S. Publication Nos. US-2016-0137126; US-2015-0352953; US-2015-0296135; US-2015-0294169; US-2015-0232030; US-2015-0022664; US-2015-0015710; US-2015-0009010 and/or US-2014-0336876, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in International Publication Nos. WO 2010/144900; WO 2013/043661 and/or WO 2013/081985, and/or U.S. Pat. No. 9,126,525, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular control system, said vehicular control system comprising:
a cabin monitoring system disposed in an interior cabin of a vehicle, wherein said cabin monitoring system comprises at least one camera disposed in the interior cabin of the vehicle, said at least one camera viewing at least a portion of the interior cabin of the vehicle, said at least one camera capturing image data;
wherein said cabin monitoring system comprises an image processor for processing image data captured by said at least one camera;
a climate control system of the vehicle that is operable to adjust cabin temperature at individual zones of multiple zones within the interior cabin of the vehicle;
a control operable to control a cabin temperature setting of the climate control system of the vehicle;
wherein said cabin monitoring system, responsive to processing by said image processor of image data captured by said at least one camera, detects presence of an occupant in the interior cabin of the vehicle;
wherein said cabin monitoring system identifies the detected occupant via processing by said image processor of captured image data;
wherein said cabin monitoring system, responsive to identifying the detected occupant as an occupant associated with a stored profile, adjusts the cabin temperature setting based on the stored profile for the individual zone within the interior cabin of the vehicle at which the identified occupant is present;
wherein said cabin monitoring system wirelessly receives, from a source remote from the vehicle, a remotely-provided profile associated with a future occupant of the vehicle; and
wherein said control, responsive to receiving the remotely-provided profile associated with the future occupant of the vehicle, and prior to arriving at a location for picking up the future occupant, adjusts the cabin temperature setting of at least one zone of the multiple zones based on the remotely-provided profile associated with the future occupant.

2. The vehicular control system of claim 1, wherein said control, after picking up the future occupant, receives an update to the remotely-provided profile associated with the future occupant and adjusts the cabin temperature setting of the zone at which the future occupant is present based on the updated profile associated with the future occupant.

3. The vehicular control system of claim 1, wherein said cabin monitoring system identifies the detected occupant via receiving a signal from a smartphone of the occupant, and wherein the signal includes information indicative of a preselected cabin temperature setting of that occupant.

4. The vehicular control system of claim 3, wherein said control receives the signal upon entry of the vehicle by that occupant.

5. The vehicular control system of claim 1, wherein said cabin monitoring system wirelessly receives, from the source remote from the vehicle, the remotely-provided profile associated with the future occupant of the vehicle when the future occupant requests the vehicle to pick up the future occupant.

6. The vehicular control system of claim 1, wherein said control adjusts a lighting system of the vehicle based on the remotely-provided profile associated with the future occupant.

7. The vehicular control system of claim 1, wherein said control adjusts an audio system of the vehicle based on the remotely-provided profile associated with the future occupant.

8. The vehicular control system of claim 1, wherein the vehicle comprises an autonomous vehicle and the detected occupant is a passenger of the autonomous vehicle.

9. The vehicular control system of claim 1, wherein said cabin monitoring system detects presence of multiple occupants in the interior cabin of the vehicle, and wherein said cabin monitoring system determines the respective individual zone of the vehicle where the respective occupant is detected, and wherein said control, responsive to detecting presence of multiple occupants in the interior cabin of the vehicle at respective zones of the vehicle, determines a temperature in the interior cabin of the vehicle at the individual zones, and wherein said control, responsive to determined temperatures in the interior cabin of the vehicle at the individual zones, adjusts the cabin temperature setting of the climate control system for the multiple zones of the interior cabin of the vehicle in accordance with preselected settings for the detected and identified occupants at the respective zones.

10. A vehicular control system, said vehicular control system comprising:
a cabin monitoring system disposed in an interior cabin of a vehicle, wherein said cabin monitoring system comprises at least one camera disposed in the interior cabin of the vehicle, said at least one camera viewing at least a portion of the interior cabin of the vehicle, said at least one camera capturing image data;
wherein said cabin monitoring system comprises an image processor for processing image data captured by said at least one camera;
a climate control system of the vehicle that is operable to adjust cabin temperature at individual zones of multiple zones within the interior cabin of the vehicle;
a control operable to control a cabin temperature setting of the climate control system of the vehicle;
wherein said cabin monitoring system, responsive to processing by said image processor of image data captured by said at least one camera, detects presence of an occupant in the interior cabin of the vehicle;
wherein said cabin monitoring system identifies the detected occupant via at least one selected from the group consisting of (i) processing by said image processor of captured image data and (ii) receiving a signal from a smartphone of the detected occupant;
wherein said cabin monitoring system, responsive to identifying the detected occupant as an occupant associated with a stored profile, adjusts the cabin temperature setting based on the stored profile for the individual zone within the interior cabin of the vehicle at which the identified occupant is present;
wherein said cabin monitoring system wirelessly receives, from a source remote from the vehicle, a remotely-provided profile associated with a future occupant of the vehicle;
wherein said cabin monitoring system wirelessly receives, from the source remote from the vehicle, the remotely-provided profile associated with the future occupant of the vehicle when the future occupant requests the vehicle to pick up the future occupant;
wherein said control, responsive to receiving the remotely-provided profile associated with the future occupant of the vehicle, and prior to arriving at a location for picking up the future occupant, adjusts the cabin temperature setting of at least one zone of the multiple zones based on the remotely-provided profile associated with the future occupant; and
wherein said control, after picking up the future occupant, receives an update to the remotely-provided profile associated with the future occupant and adjusts the cabin temperature setting of the zone at which the future occupant is present based on the updated profile associated with the future occupant.

11. The vehicular control system of claim 10, wherein said cabin monitoring system identifies the detected occupant via receiving a signal from a smartphone of the occupant, and wherein the signal includes information indicative of a preselected cabin temperature setting of that occupant.

12. The vehicular control system of claim 11, wherein said control receives the signal upon entry of the vehicle by that occupant.

13. The vehicular control system of claim 10, wherein said control adjusts a lighting system of the vehicle based on the remotely-provided profile associated with the future occupant.

14. The vehicular control system of claim 10, wherein said control adjusts an audio system of the vehicle based on the remotely-provided profile associated with the future occupant.

15. The vehicular control system of claim 10, wherein the vehicle comprises an autonomous vehicle and the detected occupant is a passenger of the autonomous vehicle.

16. The vehicular control system of claim 10, wherein said cabin monitoring system detects presence of multiple occupants in the interior cabin of the vehicle, and wherein said cabin monitoring system determines the respective individual zone of the vehicle where the respective occupant is detected, and wherein said control, responsive to detecting presence of multiple occupants in the interior cabin of the vehicle at respective zones of the vehicle, determines a temperature in the interior cabin of the vehicle at the individual zones, and wherein said control, responsive to determined temperatures in the interior cabin of the vehicle at the individual zones, adjusts the cabin temperature setting of the climate control system for the multiple zones of the interior cabin of the vehicle in accordance with preselected settings for the detected and identified occupants at the respective zones.

17. A vehicular control system, said vehicular control system comprising:
a cabin monitoring system disposed in an interior cabin of a vehicle, wherein said cabin monitoring system comprises at least one camera disposed in the interior cabin of the vehicle, said at least one camera viewing at least a portion of the interior cabin of the vehicle, said at least one camera capturing image data;
wherein said cabin monitoring system comprises an image processor for processing image data captured by said at least one camera;
a climate control system of the vehicle that is operable to adjust cabin temperature at individual zones of multiple zones within the interior cabin of the vehicle;
a control operable to control a cabin temperature setting of the climate control system of the vehicle;
wherein said cabin monitoring system wirelessly receives, from a source remote from the vehicle, a remotely-provided profile associated with a future occupant of the vehicle;
wherein said cabin monitoring system wirelessly receives, from the source remote from the vehicle, the remotely-provided profile associated with the future occupant of the vehicle when the future occupant requests the vehicle to pick up the future occupant;
wherein said control, responsive to receiving the remotely-provided profile associated with the future occupant of the vehicle, and prior to arriving at a location for picking up the future occupant, adjusts the cabin temperature setting of at least one zone of the multiple zones based on the remotely-provided profile associated with the future occupant;
wherein, after picking up the future occupant, and responsive to the future occupant updating the remotely-provided profile associated with the future occupant, the control adjusts the cabin temperature setting of the zone at which the future occupant is present based on the updated profile associated with the future occupant; and
wherein the vehicle comprises an autonomous vehicle and the detected occupant is a passenger of the autonomous vehicle and the future occupant is a future passenger of the autonomous vehicle.

18. The vehicular control system of claim 17, wherein said control adjusts a lighting system of the vehicle based on the remotely-provided profile associated with the future occupant.

19. The vehicular control system of claim 17, wherein said control adjusts an audio system of the vehicle based on the remotely-provided profile associated with the future occupant.

20. The vehicular control system of claim 17, wherein said cabin monitoring system detects presence of an occupant in the interior cabin of the vehicle and identifies the detected occupant via processing by said image processor of captured image data, and wherein said cabin monitoring system, responsive to identifying the detected occupant as an occupant associated with a stored profile, adjusts the cabin temperature setting based on the stored profile for the individual zone within the interior cabin of the vehicle at which the identified occupant is present.

21. The vehicular control system of claim 20, wherein said cabin monitoring system detects presence of multiple occupants in the interior cabin of the vehicle, and wherein said cabin monitoring system determines the respective individual zone of the vehicle where the respective occupant is detected, and wherein said control, responsive to detecting presence of multiple occupants in the interior cabin of the vehicle at respective zones of the vehicle, determines a temperature in the interior cabin of the vehicle at the individual zones, and wherein said control, responsive to determined temperatures in the interior cabin of the vehicle at the individual zones, adjusts the cabin temperature setting of the climate control system for the multiple zones of the interior cabin of the vehicle in accordance with preselected settings for the detected and identified occupants at the respective zones.
